(19) United States
(12) Patent Application Publication
(10) Pub. No.: US 2005/0140264 A1
(43) Pub. Date: Jun. 30, 2005

(54) Funnel for cathode ray tube

(75) Inventors: Haijme Makio, Shiga (JP); Masaya Kyono, Shiga (JP); Shigeyoshi Ito, Shiga (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIPPON ELECTRIC GLASS CO., LTD., Otsu-shi (JP)

(21) Appl. No.: 11/054,944

(22) Filed: Feb. 11, 2005

Related U.S. Application Data
(63) Continuation-in-part of application No. 09/787,953, filed on Mar. 23, 2001.

(51) Int. Cl. H01J 29/86

(52) U.S. Cl. 313/477 R

(57) ABSTRACT

Upper end edges (7a, 7b, 7c) of positioning reference portions (5a, 5b, 5c) are formed on the outer walls of a funnel (1) for cathode ray tube at distances (downwardly) toward a narrow open end (3) of the funnel from a maximum profile line (4), which is formed in the vicinity of or on a wide open end (2). Thus, molding defects such as deficiency and wrinkle resulting from insufficient filling of glass can be avoided, which are likely to occur in reference surfaces (6a, 6b, 6c) of the positioning reference portions. The present invention eliminates occurrences of small cracks caused by concentration of heat stress, to improve the productivity of the funnel.

### FIELD OF THE INVENTION

The present invention relates to a funnel which is a constituent of a glass bulb for cathode ray tube.

### BACKGROUND OF THE INVENTION

A glass bulb for cathode ray tube usually comprises a front panel on which an image is to be displayed, a funnel disposed behind the panel and sealed with the panel, on outside of which a deflection yoke is attached, and a neck welded with the funnel for accommodating an electron gun therein.

The panel on which an image is displayed has a generally rectangular shape, and also a wide open end of the funnel sealed with the panel has a generally rectangular shape similar to that of the panel. Further, the neck in which an electron gun is accommodated has a cylindrical shape, and also a narrow open end of the funnel welded with the neck has a similar circular shape.

In order to provide a cathode ray tube to properly display an image without displacement of color, it is important to be assembled by precisely positioning the respective axes of the panel, the funnel and the neck with respect to the tube axis of the glass bulb. In order to accomplish this, on outer walls of sides of the funnel which are adjacent to each other is provided with a plurality of positioning reference portions which are used to be abutted to a jig at the time of sealing with the panel (See, for example, Japanese Unexamined Patent Publications JP-A 63-10447 (SHO-63, 1988), JP-A 9-245646 (HEI-9, 1997), JP-A 8-111189 (HEI-8, 1996) and JP-A2002-503629(2002)). The reference surfaces of the positioning reference portions are formed at a predetermined distance from the axis of the funnel.

FIG. 11 is a perspective view of a conventional funnel for cathode ray tube disclosed in the above-mentioned publications and the like, and FIG. 12 is a sectional view of the essential part of the positioning reference portion thereof. In the drawings, the reference numeral 1 denotes a funnel, the reference numeral 2 denotes a wide open end, the reference numeral 3 denotes a narrow open end, the reference numeral 4 denotes a maximum profile line, the reference numerals 5a, 5b, 5c denote positioning reference portions, the reference numerals 6a, 6b, 6c denote reference surfaces of the respective reference portions, and the reference numerals 7a, 7b, 7c denote upper end edges of the respective reference portions.

Conventionally, these upper end edges 7a, 7b, 7c of the positioning reference portions of the funnel for cathode ray tube are formed as corresponding to the maximum profile line 4 formed by mold matching of a bottom mold 10 and a shell mold 11.

In other words, as shown in FIG. 13, the aforementioned funnel 1 is generally press-molded by supplying a forming mold consisting of a bottom mold 10 and a shell mold 11 with a molten glass gob of high temperature, and then causing a plunger mold 12 to move down so as to extend the molten glass gob by pressing. After molding, the plunger mold 12 is moved up, and after removing the shell mold 11, the funnel 1 is removed from a bottom mold 10.

As shown in FIG. 13, the bottom mold 10 has recess portions to provide the molding surfaces of the positioning reference portions 5a, 5b, 5c, and the uppermost part of the bottom mold 10 is free or not closed in order to remove the funnel 1 from the bottom mold 10 after press molding. Consequently, the upper end edges 7a, 7b, 7c of the positioning reference portions are located at the positions as corresponding to the maximum profile line 4 formed by mold matching of the bottom mold 10 and the shell mold 11.

As described above, the upper end edge 7a of the positioning reference portion 5a (ditto for 5b, 5c) of the conventional funnel corresponds to the maximum profile line 4 formed in the vicinity of the wide open end 2 of the funnel 1 as a result of mold matching of forming mold consisting of the bottom mold 10 and the shell mold 11, and moreover, the positioning reference portion 5a is formed as being projected outside the maximum profile line 4.

For this reason, press molding of the funnel forms the positioning reference portion 5a from glass, of which temperature has slightly decreased in the substantially final stage of the molding process where the molten glass gob supplied to the bottom mold 10 is extended by pressing toward the neighborhood of the wide open end formed by the shell mold 11, and moreover the positioning reference portion 5a is projected to the outside from the outer wall of the funnel, resulting in that not-filled (a defect that the positioning reference portion 5a is not completely filled with the glass) or wrinkling is likely to occur in the corresponding reference surface 6a.

Furthermore, chipping sometimes occurs in the corner between the reference surface 6a of the positioning reference portion 5a and the upper end edge 7a because of flash of glass formed by mold matching of forming mold consisting of the shell mold 11 and the bottom mold 10. Additionally, at the positioning reference portion 5a where wall thickness suddenly changes, small cracking is caused by concentration of heat stress at the upper end edge 7a resulting in breakage of the entire funnel.

It is therefore an object of the invention to suppress molding defects such as not-filled, wrinkling and chipping in the positioning reference portion formed on the outer wall of the funnel for cathode ray tube, and to avoid occurrence of small cracking caused by concentration of heat stress generated at the upper end edge of the reference portion, thereby improving the productivity of the funnel.

### SUMMARY OF THE INVENTION

The present invention has been made to solve the above-mentioned objects, and provides a funnel for use in a cathode ray tube comprising: a wide open end having a rectangular opening, extending horizontally; a narrow open end having a circular opening, opposing the wide open end; an outer wall extending between the wide open end and the narrow open end, intercommunicating between the rectangular opening and the circular opening, wherein the outer wall has a maximum profile line below and in the vicinity of the wide open end; and a plurality of positioning reference portion provided below and/or in the vicinity of the maximum profile line on the outer wall, wherein the positioning reference portion is used for sealing a cathode ray tube panel, wherein the rectangular opening has a center, and wherein the funnel has an axis vertically running through the center, and wherein the positioning reference portion has a reference surface formed inside or as corresponding to the maximum profile line, when viewed from the axis. Besides, this invention is a funnel for use in a cathode ray tube comprising: a wide open end having a rectangular opening, extending horizontally; a narrow open end having a circular opening, opposing the wide open end; an outer wall extending between the wide open end and the narrow open end, intercommunicating between the rectangular opening and the circular opening, wherein the outer wall has a maximum profile line; and a plurality of positioning reference portion provided below the maximum profile line on the outer wall, wherein the positioning reference portion is used for sealing a cathode ray tube panel, wherein the rectangular opening has a center, wherein the funnel has an axis vertically running through the center, wherein the positioning reference portion has a reference surface formed outside the maximum profile line when viewed from the axis, wherein the positioning reference portion has an upper end edge, a lower end edge and a reference surface extending between the upper end edge and the lower end edge, and wherein the reference surface is inclined toward the axis as descending from the upper end edge to the lower end edge. The reference surface formed inside the maximum profile line may be formed such that the entire reference line surface is formed inside the maximum profile line, when viewed from the axis. The reference surface formed outside the maximum profile line may be formed such that the entire reference surface is formed outside the maximum profile line, when viewed from the axis. Also, the reference surface formed as corresponding to the maximum profile line may be formed such that at least one part of the reference surface is corresponding to the maximum profile line, when viewed from the axis.

Furthermore, the present invention is characterized in that the positioning reference portion has an upper end edge formed not to be projected from the outer wall.

Furthermore, the present invention is characterized in that the positioning reference portion has an upper end edge formed to be projected from the outer wall.

Furthermore, the present invention is characterized in that the positioning reference portion has an upper end edge formed 3 mm or more below the maximum profile line.

Furthermore, the present invention is characterized in that the positioning reference portion has an upper end edge formed in the vicinity of and below the maximum profile line, to satisfy the formula of h≦0.2H, where “h” represents a vertical distance between the maximum profile line and an upper end edge of the positioning reference portion, and “H” represents a vertical distance between the wide open end and the narrow open end. If h>0.2H, it becomes difficult to hold the funnel in a stable manner at the time of sealing the panel while the wide open end of the funnel being directed upward and a jig is abutted to the positioning reference surface, because the positioning reference portion is close to the center of gravity of the funnel or located in a lower position than the center of gravity of the funnel.

Furthermore, the present invention is characterized in that the positioning reference portion has an upper end edge, a lower end edge and a reference surface extending between the upper end edge and the lower end edge, wherein the reference surface is inclined toward the axis as descending from the upper end edge to the lower end edge.

Furthermore, the present invention is characterized in that the maximum profile line is formed below the wide open end.

Furthermore, the present invention is characterized in that the maximum profile line is formed on the wide open end.

According to the present invention, since the positioning reference portion is formed at a distance from the maximum profile line of the funnel toward the narrow open end, the upper end edge of the positioning reference portion does not correspond to and is located below the maximum profile line unlike the conventional ones. Since the positioning reference portion is formed there before decreasing the temperature of glass, it is possible to suppress molding defects such as not-filled, wrinkling, chipping and the like which might occur in the reference portion.

Furthermore, by forming the positioning reference portion at the position inside the maximum profile line when viewed from the axis running through the center of the rectangular opening, it is possible to reduce the amount by which the reference surface thereof is projected from the outer wall of the funnel vertically outward the axis of the funnel, to relieve the change in wall thickness in the portion in question because the wall thickness of the positioning reference portion gradually is increased downwardly from the upper end edge thereof, allowing production of a funnel for cathode ray tube without generating small crack from the upper end edge due to concentration of heat stress as described above, and thereby enabling simple handling by eliminating the portion projected to the outside from the maximum profile line.

Furthermore, by forming the reference surface to be inclined toward the axis as descending from the upper end edge to the lower end edge, it is possible to reduce the amount by which the reference surface thereof is projected from the outer wall of the funnel vertically outward the axis of the funnel, to relieve the change in wall thickness in the portion of the lower end edge, allowing production of a funnel for cathode ray tube without generating a small crack from the lower end edge due to concentration of heat stress. It is also possible to improve releasability of removing the funnel from the mold and to effectively avoid occurrence of scratches or minute cracks on the reference surface.

Furthermore, by forming the upper end edge of the positioning reference portion not to be projected from the outer wall, it is possible to reduce the amount by which the reference surface thereof is projected from the outer wall of the funnel vertically outward the axis of the funnel, to relieve the change in wall thickness in the portion in question.

Furthermore, by forming the upper end edge of the positioning reference portion to be projected from the outer wall, it becomes easier to grind a reference surface thereof so as to more precisely adjust the distance between the reference surface and the axis of the funnel.

Furthermore, when setting “h” to satisfy 3 mm≦h, the positioning reference portion is formed in the stage sufficiently earlier than that the molten glass gob has extended by pressing to reach the wide open end, resulting in further suppressing the occurrence of molding defects such as not-filled, wrinkling, chipping and the like.

On the other hand, when setting “h” and “H” to satisfy h≦0.2H, it is possible to hold the funnel in a stable manner at a higher position than the center of gravity of the funnel, at the time of sealing the funnel with the panel while the wide open end of the funnel is directed upward and while a jig is abutted to the positioning reference surface.

Furthermore, this invention can be applied to a funnel having a maximum profile line below the wide open end. In this case, the wall having the maximum profile line may be formed by mold matching of the bottom and shell mold as described before.

In addition to forming the maximum profile line in the vicinity or below the wide open end line as explained above, this invention can be applied to a funnel having an outer wall having a maximum profile line on the wide open end. In this case, the wall having the maximum profile line on the wide open end may be formed either by grinding the wide open end where the maximum profile line exists below the wide open end or by only press molding. Also, in the invention applied to the funnel having an outer wall having a maximum profile line on the wide open end, a funnel having chamfer portions at the corner connecting the wide open end and the outer wall should be interpreted as a funnel having an outer wall having a maximum profile line on the wide open end.

### BRIEF EXPLANATION OF THE DRAWINGS

FIG. 1 is a perspective view showing a funnel for cathode ray tube according to the present invention.

FIG. 2 is a sectional view of essential part along the line A-A1 of FIG. 1, showing a positioning reference portion of the funnel for cathode ray tube according to the present invention.

FIG. 3 is a sectional view of essential part of a mold configuration used for press molding of the funnel for cathode ray tube according to the present invention.

FIG. 4 is a sectional view of essential part along the line A-A1 of FIG. 1, showing a positioning reference portion of another funnel for cathode ray tube according to the present invention.

FIG. 5 is a sectional view of essential part along the line A-A1 of FIG. 1, showing a positioning reference portion of another funnel for cathode ray tube according to the present invention.

FIG. 6 is a sectional view of essential part along the line A-A1 of FIG. 1, showing a positioning reference portion of another funnel for cathode ray tube according to the present invention.

FIG. 7 is a sectional view of essential part along the line A-A1 of FIG. 1, showing a positioning reference portion of another funnel for cathode ray tube according to the present invention.

FIG. 8 is a sectional view of essential part along the line A-A1 of FIG. 1, showing a positioning reference portion of another funnel for cathode ray tube according to the present invention.

FIG. 9 is a sectional view of essential part along the line A-A1 of FIG. 1, showing a positioning reference portion of another funnel for cathode ray tube according to the present invention.

FIG. 10 is a perspective view of essential part of a bottom mold configuration used for press molding of another funnel showing in FIGS. 5 to 9 for cathode ray tube according to the present invention.

FIG. 11 is a perspective view of a conventional funnel for cathode ray tube.

FIG. 12 is a sectional view of essential part along the line A-A1 of FIG. 11, showing a positioning reference portion of the conventional funnel for cathode ray tube.

FIG. 13 is a partial sectional view of essential part of a mold configuration used for press molding of the conventional funnel for cathode ray tube.

### DETAILED DESCRIPTION OF THE PREFERRED EMBODIMENTS

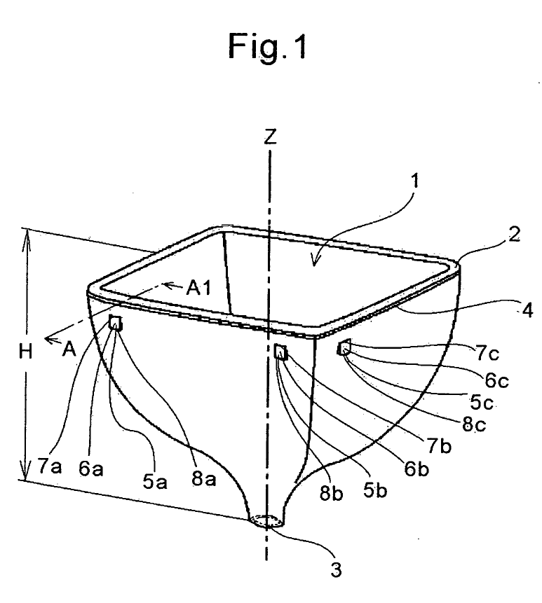

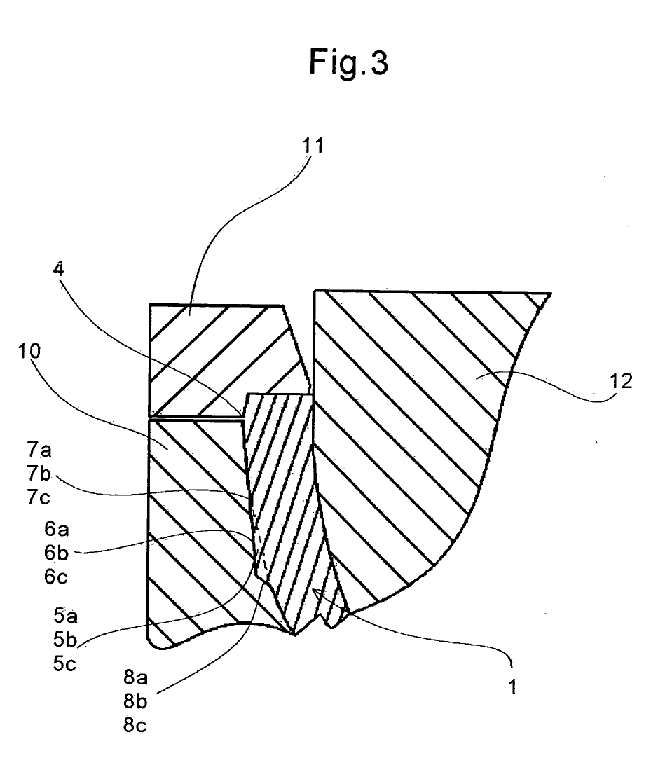

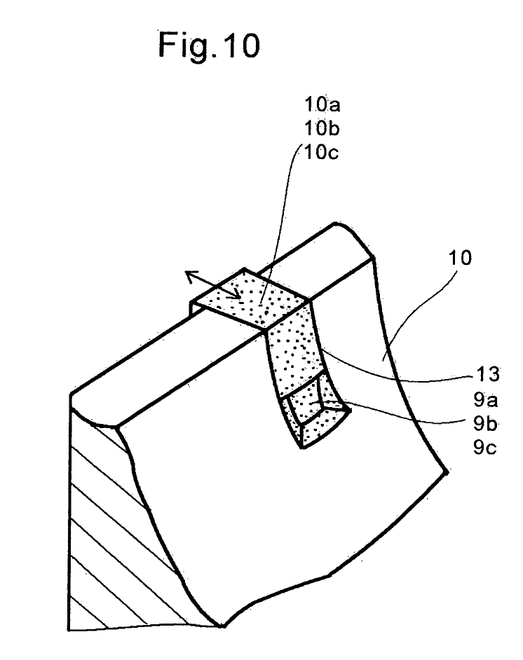

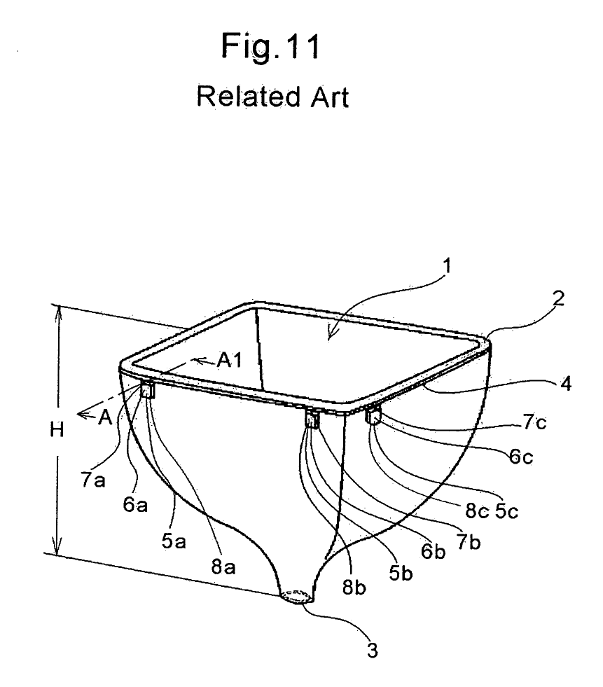

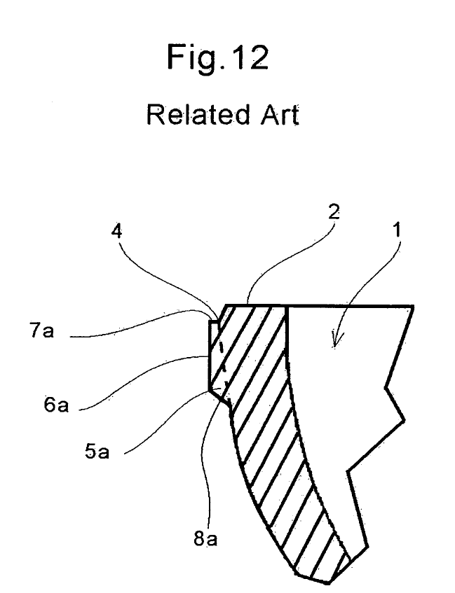

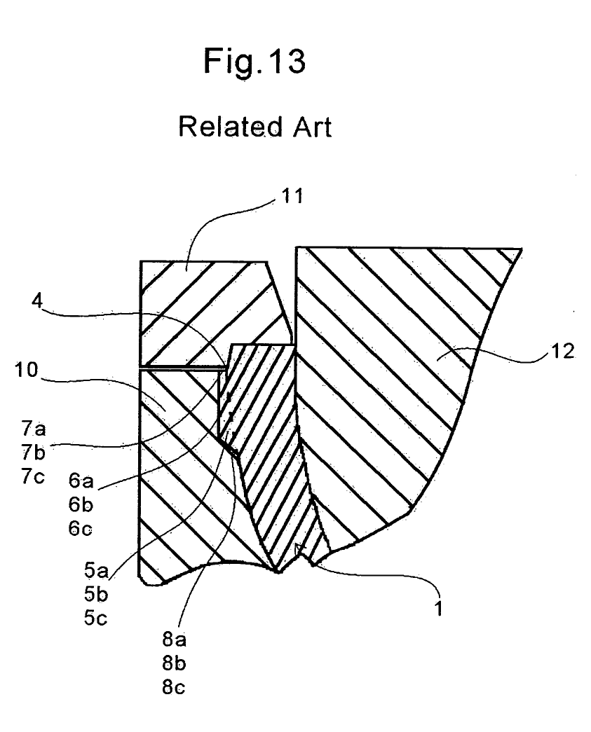

In the following, embodiments of funnels for cathode ray tube according to the present invention will be explained with reference to FIGS. 1 to 10. FIGS. 1, 2 and 4 to 9 show funnels for cathode ray tube according to the present invention, and FIGS. 3 and 10 show a mold configuration suitable for press molding of the funnel according to the present invention. In FIGS. 1 to 10, the same portions and the equivalent portions as described above with regard to FIGS. 11, 12 and 13 are denoted by the same reference numerals.

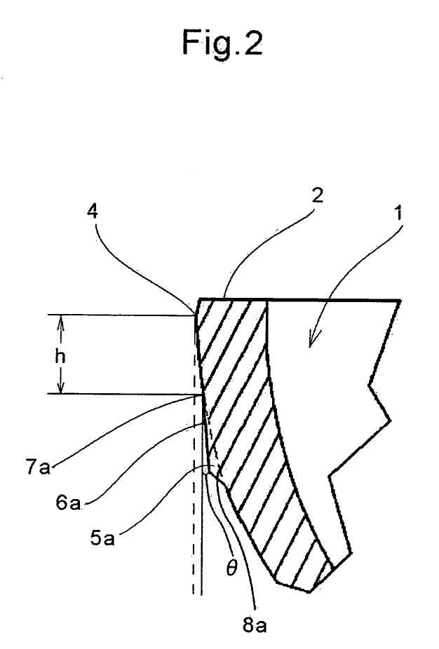

In FIGS. 1 and 2, the funnel 1 has a plurality of positioning reference portions 5a, 5b, 5c on outer walls of the neighboring sides, and in the case of a funnel for cathode ray tube of 29 inches, for example, a distance in “H” from a wide open end 2 to a narrow open end 3 is 353 mm, and a distance in “h” from a maximum profile line 4 to upper end edges 7a, 7b, 7c of the positioning reference portions 5a, 5b, 5c is 12 mm. Furthermore, the upper end edges 7a, 7b, 7c are formed not to be projected from the outer wall of the funnel. Furthermore, positioning reference surfaces 6a, 6b, 6c are formed at positions (inside) distanced approximately 1 mm from the maximum profile line 4 when viewed from the axis Z vertically running through the center of the rectangular opening(referred merely to “positions inside” hereinafter). Moreover, the positioning reference surfaces 6a, 6b, 6c are formed to be inclined, for example, in θ=0.25°, toward the axis Z from the upper end edges 7a, 7b, 7c to lower end edges 8a, 8b, 8c of the positioning reference portions (referred merely to “to be inclined” hereinafter).

As shown in FIG. 3, the funnel 1 according to the present invention is produced by means of a press forming mold configuration formed by a bottom mold 10, a shell mold 11 and a plunger mold 12. This configuration provides molding surfaces for the positioning reference portions 5a, 5b, 5c on the bottom mold 10 below the upper end of the bottom mold 10, which affords the maximum profile line 4 of the funnel with being distanced therefrom.

As a result, the positioning reference portions 5a, 5b, 5c of the funnel 1 are formed to be spaced from the maximum profile line 4 on the side of the narrow open end 3, and in addition, the positioning reference surfaces 6a, 6b, 6c are formed inside the maximum profile line 4.

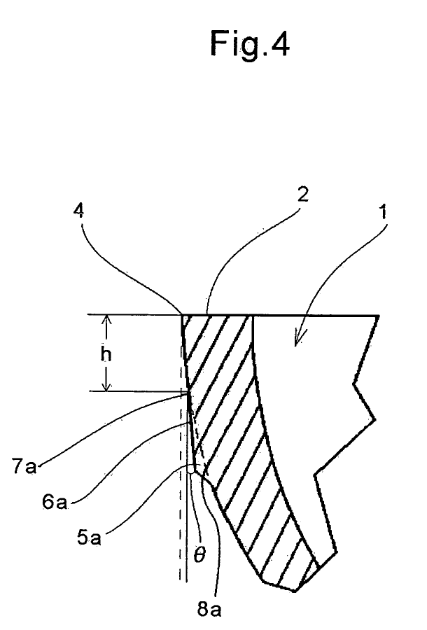

In the above-mentioned embodiment, as shown in FIG. 2, the maximum profile line is formed below the wide open end 2 of the funnel 1, however, as shown in FIG. 4, it is also possible to have a configuration that the maximum profile line is formed on the wide open end 2. The funnel 1 shown in FIG. 4 is formed either by grinding of a surface of the wide open end 2 at least till the position of the maximum profile line 4 or by using a press forming mold configuration. The latter forms the maximum profile line 4 on the wide open end 2 without grinding the wide open end 2.

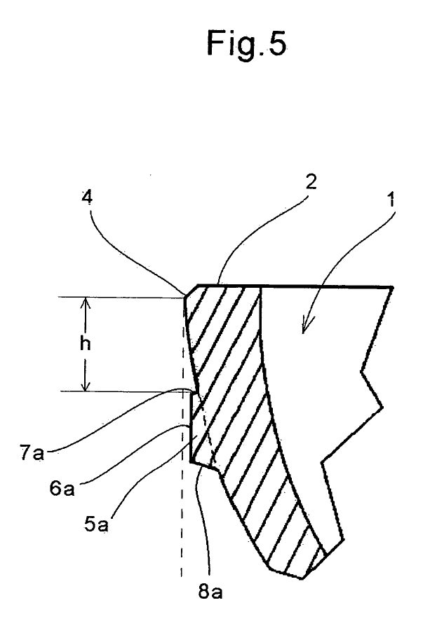

In the above-mentioned two embodiments as shown in FIG. 2 and FIG. 4, the positioning reference portions 5a, 5b, 5c are formed such that the sides of the upper end edges 7a, 7b, 7c thereof are not be projected from the outer wall surfaces of the funnel 1, however, as shown in FIGS. 5 to 9, it is also possible to use a configuration that the positioning reference portions 5a, 5b, 5c of the funnel 1 are formed at positions distanced from the maximum profile line 4 toward the narrow open end 3, and the upper end edges 7a, 7b, 7c of the positioning reference portions 5a, 5b, 5c are also projected as same as the lower end sides thereof.

In FIGS. 5, 6 and 8, the funnel 1 has a configuration that the maximum profile line is formed below the wide open end 2 of the funnel 1.

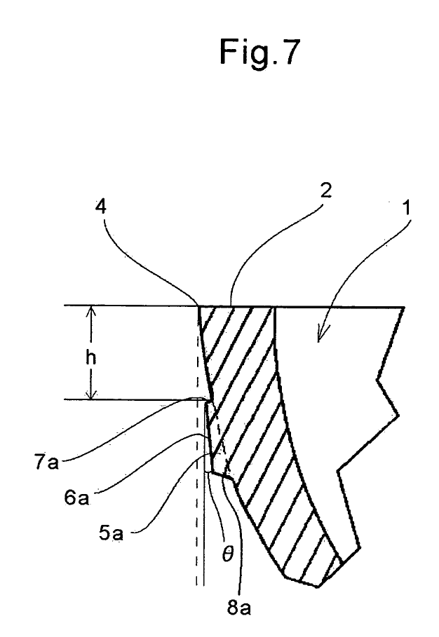

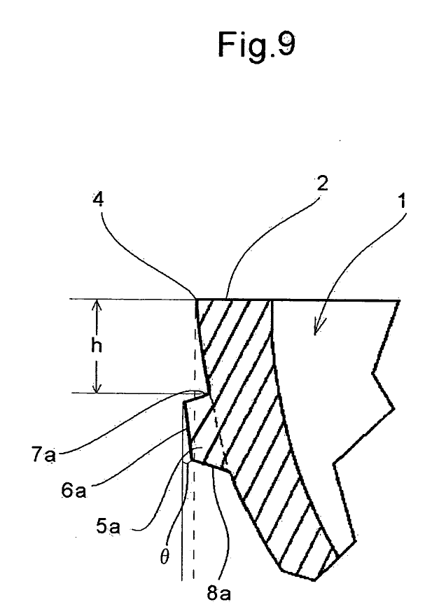

On the other hand, in FIGS. 7 and 9, the funnel 1 has a configuration that the maximum profile line is formed on the wide open end 2 of the funnel 1.

In FIG. 5, the funnel 1 has reference portions 5a, 5b, 5c having reference surfaces 6a, 6b, 6c formed at positions, which are located inside and is not inclined.

As illustrated in FIGS. 2, 4-6 and 7, the reference surface of the present invention is formed inside the maximum profile line when viewed from the axis, and thus, the reference surface is located inside the dashed line in the drawings. Alternatively, the reference surface of the present invention may be formed as corresponding to the maximum profile line when viewed from the axis, so that the reference surface is located on the dashed line in the drawings.

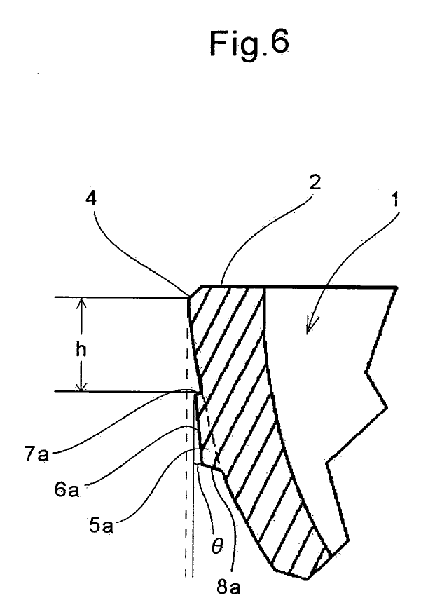

In FIGS. 6 and 7, the funnel 1 has reference portions 5a, 5b, 5c having reference surfaces 6a, 6b, 6c formed at positions, which are located inside and inclined.

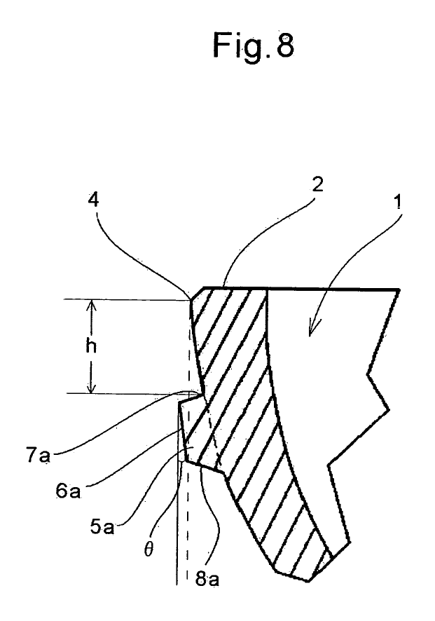

In FIGS. 8 and 9, the funnel 1 has reference portions 5a, 5b, 5c having inclined reference surfaces 6a, 6b, 6c formed at position outside from the maximum profile line 4 when viewed from the axis Z vertically running through the center of rectangular opening.

Also in the embodiments as shown in FIGS. 2, 4 and 7, the reference portions 5a, 5b, 5c having reference surfaces 6a, 6b, 6c, which are not inclined, can be employed.

In the above cases, however, in order to provide the molding surfaces for the positioning reference portions 5a, 5b, 5c on the bottom mold 10, for example, the configuration as shown in FIG. 10 is employed. That is, at the positions where the molding surfaces for the positioning reference portions 5a, 5b, 5c are formed, slits 13 are formed to be extended from the upper end surface of the bottom mold 10, and sliding pieces 10a, 10b, 10c are configured in a manner to slide in the direction of the arrow with respect to the bottom mold 10. The sliding pieces have formed molding surfaces 9a, 9b, 9c for forming the positioning reference portions 5a, 5b, 5c, and are fitted into the slits 13.

After making the funnel 1 by press molding by using the bottom mold 10, which has the sliding pieces 10a, 10b, 10c fitted therein, the shell mold 11 and the plunger mold 12, the plunger mold 12 is first moved up, the shell mold 11 is then removed, and the sliding pieces 10a, 10b, 10c are finally moved outwardly in the direction of arrow, to thereby remove the press molded funnel 1 from the bottom mold 10.

Also in the present embodiment, the positioning reference portions 5a, 5b, 5c are formed before decreasing the temperature of the glass so that the molten glass gob can be pressed and extended to reach the upper wide open end 2, and thereby to suppress occurrences of molding defects such as not-filled, wrinkling and chipping as described above.

Moreover, according to the present embodiment, in order to adjust the positions of the positioning reference portions 5a, 5b, 5c, a plurality of sliding pieces are prepared, which have the molding surfaces 9a, 9b, 9c for forming the positioning reference portions 5a, 5b, 5c located at positions different from each other. The positions of the positioning reference portions 5a, 5b, 5c can be readily adjusted by replacing these sliding pieces. Furthermore, fine adjustment of the fixing positions of the sliding directions of the sliding pieces 10a, 10b, 10c can change the positions of the reference surfaces 6a, 6b, 6c.

In the embodiments of the present invention, a pad-like positioning reference portion is used as an example, however, any shapes can be used as far as the reference surface of the positioning reference portion is formed at a predetermined distance from the axis of the funnel; a required area of abutment with a jig is secured; and positioning of the funnel can be properly achieved when sealing with the panel.

In addition, at least three positioning reference portions are required in total so as to be sealed accurately with a panel, however, additional pieces of the positioning reference portion can be formed, if necessary.

### UTILITY IN THE INDUSTRIAL FIELD

According to the funnel for cathode ray tube of the present invention, the positioning reference portions are formed at distances from the maximum profile line toward the narrow open end, so that occurrences of molding defects such as not-filled, wrinkling, chipping and the like can be suppressed, to thereby improve the productivity of the funnel.

Furthermore, according to the present invention, the positioning reference surfaces are formed at positions distanced inside the maximum profile line, or formed as corresponding to the maximum profile line, when viewed from the axis, so as to reduce the amount by which the positioning reference surface projects from the outer wall of the funnel vertically and outwardly with respect to the axis of the funnel. Thus, the change in wall thickness of the portion in question is relieved, and it is advantageous that a funnel for cathode ray tube can be produced which avoids small crack.

1. A funnel for use in a cathode ray tube comprising: a wide open end having a rectangular opening, extending horizontally; a narrow open end having a circular opening, opposing the wide open end; an outer wall extending between the wide open end and the narrow open end, intercommunicating between the rectangular opening and the circular opening, wherein the outer wall has a maximum profile line; and a plurality of positioning reference portions provided below the maximum profile line on the outer wall, wherein the positioning reference portion is used for sealing a cathode ray tube panel, wherein the rectangular opening has a center, and wherein the funnel has an axis vertically running through the center, and wherein the positioning reference portion has a reference surface formed inside the maximum profile line or formed as corresponding to the maximum profile line, when viewed from the axis.

2. A funnel for use in a cathode ray tube according to claim 1, wherein the positioning reference portion has an upper end edge formed not to be projected from the outer wall.

3. A funnel for use in a cathode ray tube according to claim 1, wherein the positioning reference portion has an upper end edge formed to be projected from the outer wall.

4. A funnel for use in a cathode ray tube according to claim 1, wherein the positioning reference portion has an upper end edge formed 3 mm or more below the maximum profile line.

5. A funnel for use in a cathode ray tube according to claim 1, wherein the positioning reference portion has an upper end edge formed to satisfy the formula of h≦0.2H, where “h” represents a vertical distance between the maximum profile line and an upper end edge of the positioning reference portion, and “H” represents a vertical distance between the wide open end and the narrow open end.

6. A funnel for use in a cathode ray tube according to claim 1, wherein the positioning reference portion has an upper end edge, a lower end edge and a reference surface extending between the upper end edge and the lower end edge, wherein the reference surface is inclined toward the axis as descending from the upper end edge to the lower end edge.

7. A funnel for use in a cathode ray tube according to claim 1, wherein the maximum profile line is formed below the wide open end.

8. A funnel for use in a cathode ray tube according to claim 1, wherein the maximum profile line is formed on the wide open end.

9. A funnel for use in a cathode ray tube comprising: a wide open end having a rectangular opening, extending horizontally; a narrow open end having a circular opening, opposing the wide open end; an outer wall extending between the wide open end and the narrow open end, intercommunicating between the rectangular opening and the circular opening, wherein the outer wall has a maximum profile line; and a plurality of positioning reference portions provided below the maximum profile line on the outer wall, wherein the positioning reference portion is used for sealing a cathode ray tube panel, wherein the rectangular opening has a center, wherein the funnel has an axis vertically running through the center, wherein the positioning reference portion has a reference surface formed outside the maximum profile line when viewed from the axis, wherein the positioning reference portion has an upper end edge, a lower end edge and a reference surface extending between the upper end edge and the lower end edge, and wherein the reference surface is inclined toward the axis as descending from the upper end edge to the lower end edge.

10. A funnel for use in a cathode ray tube according to claim 9, wherein the positioning reference portion has an upper end edge formed 3 mm or more below the maximum profile line.

11. A funnel for use in a cathode ray tube according to claim 9, wherein the positioning reference portion has an upper end edge formed to satisfy the formula of h≦0.2H, where “h” represents a vertical distance between the maximum profile line and an upper end edge of the positioning reference portion, and “H” represents a vertical distance between the wide open end and the narrow open end.

12. A funnel for use in a cathode ray tube according to claim 9, wherein the maximum profile line is formed below the wide open end.

13. A funnel for use in a cathode ray tube according to claim 9, wherein the maximum profile line is formed on the wide open end.
